(19) United States
(12) Patent Application Publication
(10) Pub. No.: US 2025/0326112 A1
(43) Pub. Date: Oct. 23, 2025

(54) SYSTEM AND METHOD FOR NATURAL LANGUAGE PROCESSING COMMAND AND CONTROL

(71) Applicant: Booz Allen Hamilton Inc., McLean, VA (US)

(72) Inventors: Kelsie Lileana Reinaltt, Centreville, VA (US); Philip Collin Richard Navarro Paran, Denver, CO (US); Jackson David Crane, San Diego, CA (US)

(73) Assignee: Booz Allen Hamilton Inc., McLean, VA (US)

(21) Appl. No.: 19/184,500

(22) Filed: Apr. 21, 2025

Related U.S. Application Data
(60) Provisional application No. 63/637,007, filed on Apr. 22, 2024.

(51) Int. Cl. B25J 9/16; G06F 40/20

(52) U.S. Cl. CPC B25J 9/1628; G06F 40/20

(57) ABSTRACT

Exemplary systems and methods are directed to reducing processing complexity for command and control of a remote autonomous object in response to natural language commands. A processor receives a user command in a natural language format and extracts designated parameters for matching with a control prompt stored in a library of control prompts. The processor determines a confidence from a result of the operation. The confidence factor is used to selectively route the user command to a simple command processing path to generate a simple command message or a complex command processing path having one or more neural networks to generate a complex command message. The processor compares the simple command objective message, or the complex command objective message generated from the selective routing operation with known capabilities of the remote autonomous object to identify a remote autonomous object command, which is formatted and transmitted to the remote autonomous object.

### CROSS-REFERENCE TO RELATED APPLICATION

This application claims priority to U.S. Provisional Application No. 63/637,007, filed Apr. 22, 2024, the disclosure of which is incorporated in its entirety for all purposes.

### FIELD

The present disclosure relates to the area of natural language processing, and more particularly to systems and methods for command and control of a remote autonomous object in response to natural language commands.

### BACKGROUND

Human teams are organized and trained to perform activities in contested environments. Remote autonomous systems, such as robots and drones can be used to supplement activities performed by users and in some instances can entirely replace a human in the field. LLMs have been used to control robots and are known to require high-performance computers and dedicated hardware to support a LLM of the size and performance capability necessary to achieve acceptable command and control. These high-performance options can be bulky and require expansive units of power to for proper operation. Smaller scale versions of the high-performance computing systems often provide are inadequate and/or inefficient for field use because they require multiple individual and/or alternative verbal commands until the remote autonomous system can understand and process the instruction so that the desired action is performed.

### SUMMARY

An exemplary method for reducing processing complexity for command and control of a remote autonomous object in response to natural language commands is disclosed, the method comprising: storing, in memory, a prompt library, a conversational library, program code for generating one or more neural networks for producing a complex command message; receiving, at a basic processor, a user command in a natural language format; extracting, by the basic processor, designated parameters from the user command for matching with a control prompt stored in a library of control prompts, and determining a confidence factor with which the matching has been performed relative to a predetermined threshold; selectively routing, by the basic processor, the user command to a simple command processing path or a complex command processing path based on the confidence factor, the simple command processing path configured for generating a simple command message that includes a simple command objective generated from the control prompt matched to the designated parameters and a conversational counterpart retrieved from a conversational library, and the complex command processing path having one or more neural networks that process the user command to extract library content identifying context and situational awareness that is semantically related to the user command, and generate a complex command message based on the library content; comparing, by the basic processor, the simple command objective message or the complex command objective message generated as a result of the selective routing, with known capabilities of the remote autonomous object to identify a remote autonomous object command; and generating a remote autonomous object command message containing the remote autonomous object command for transmission to the remote autonomous object.

An exemplary system for reducing processing complexity for command and control of a remote autonomous object in response to natural language commands, the system comprising: memory configured to store a prompt library, a conversational library, and program code for generating one or more neural networks for producing a complex command message; and a basic processor configured to: receive a user command in a natural language format; extract designated parameters from the user command for matching with a control prompt stored in a library of control prompts, and determining a confidence factor with which the matching has been performed relative to a predetermined threshold; selectively route the user command to a simple command processing path or a complex command processing path based on the confidence factor, the simple command processing path configured for generating a simple command message that includes a simple command objective generated from the control prompt matched to the designated parameters and a conversational counterpart retrieved from a conversational library, and the complex command processing path having one or more neural networks that process the user command to extract library content identifying context and situational awareness related to the user command, and generate a complex command message based on the library content; compare the simple command objective message or the complex command objective message generated as a result of the selective routing, with known capabilities of the remote autonomous object to identify a remote autonomous object command; and generate a remote autonomous object command message containing the remote autonomous object command for transmission to the remote autonomous object.

An exemplary non-transitory computer readable medium encoded with program code for performing a method for reducing processing complexity for command and control of a remote autonomous object in response to natural language commands is enclosed. The computer readable medium, when placed in communicable contact with a processor, causing the processor to perform operations comprising: storing, in memory, a prompt library, a conversational library, program code for generating one or more neural networks for producing a complex command message; receiving, at a basic processor, a user command in a natural language format; extracting, by the basic processor, designated parameters from the user command for matching with a control prompt stored in a library of control prompts, and determining a confidence factor with which the matching has been performed relative to a predetermined threshold; selectively routing, by the basic processor, the user command to a simple command processing path or a complex command processing path based on the confidence factor, the simple command processing path configured for generating a simple command message that includes a simple command objective generated from the control prompt matched to the designated parameters and a conversational counterpart retrieved from a conversational library, and the complex command processing path having one or more neural networks that process the user command to extract library content identifying context and situational awareness that is semantically related to the user command, and generate a complex command message based on the library content; comparing, by the basic processor, the simple command objective message or the complex command objective message generated as a result of the selective routing, with known capabilities of the remote autonomous object to identify a remote autonomous object command; and generating a remote autonomous object command message containing the remote autonomous object command for transmission to the remote autonomous object.

### BRIEF DESCRIPTION OF THE DRAWINGS

Exemplary embodiments are best understood from the following detailed description when read in conjunction with the accompanying drawings. Included in the drawings are the following figures:

FIG. 1A illustrates a system for command and control of a remote autonomous object in accordance with an exemplary embodiment of the present disclosure.

FIG. 1B illustrates a robot-mounted system for command and control of a remote autonomous object in accordance with an exemplary embodiment of the present disclosure.

FIG. 1C illustrates a human-mounted system for command and control of a remote autonomous object in accordance with an exemplary embodiment of the present disclosure.

FIG. 1D illustrates a server-hosted system for command and control of a remote autonomous object in accordance with an exemplary embodiment of the present disclosure.

FIG. 2 illustrates a data flow diagram for the system of FIG. 1 in accordance with an exemplary embodiment of the present disclosure.

FIG. 3 illustrates a selective routing command processing paths in accordance with an exemplary embodiment.

FIG. 4 illustrates a method for command and control of a remote autonomous object in accordance with an exemplary embodiment of the present disclosure.

FIG. 5 illustrates a hardware structure of a remote autonomous object in accordance with an exemplary embodiment of the present disclosure.

Further areas of applicability of the present disclosure will become apparent from the detailed description provided hereinafter. It should be understood that the detailed descriptions of exemplary embodiments are intended for illustration purposes only and, therefore, are not intended to necessarily limit the scope of the disclosure.

### DETAILED DESCRIPTION

The exemplary novel embodiments described herein a human-machine-teaming solution where a user can verbally interact with a network of robotic assets. The solution allows for users to communicate with a network of robots in natural human language. The system can be configured to determine the user's intent using a combination of natural language processing and large language models. The system can be executed at the edge and reside in a closed and restricted network of an isolated environment. The system includes a processing device and memory, where the processing device is configured to select between two paths (i.e., simple or complex) in the processing device for processing user's verbal command to generate a control message for instructing the robotic asset to perform an action. Because the complex processing path is not the single and/or default processing option for every received verbal command, the system allows for a reduction in computational overhead and power consumption by processing devices in isolated environments. Moreover, the reduction in computational overhead allows the system to be arranged with smaller components (e.g., memory, processing device, etc.) which can lead to reduced size and weight of the system.

Users can issue commands for the robots to perform tasks, and the assets can report on findings and/or provide feedback to a user based on stored information and real-time inputs. Assets can also be proactive and raise concerns to the user. The exemplary embodiments of the present disclosure include novel solutions for using onboard circuitry to process natural language verbal inputs/commands to determine the intent of human users, and if an action is to be performed, pass the action to the identified robotic asset for execution.

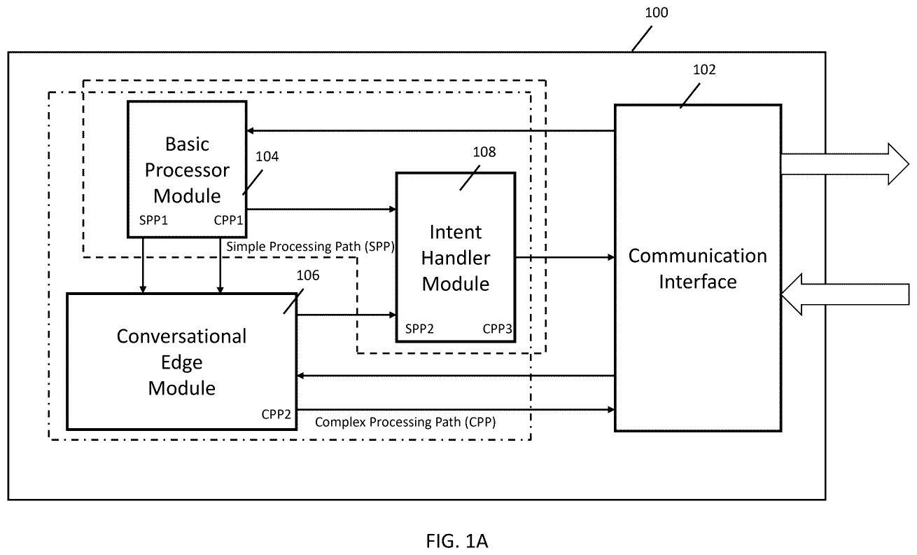

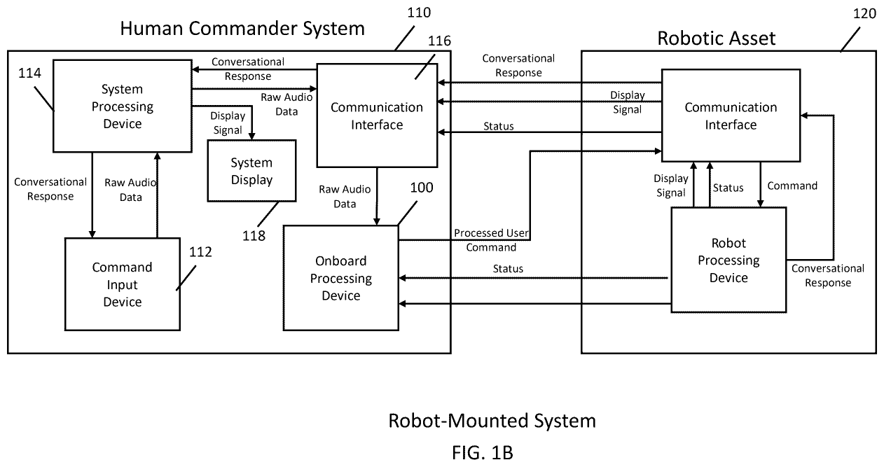

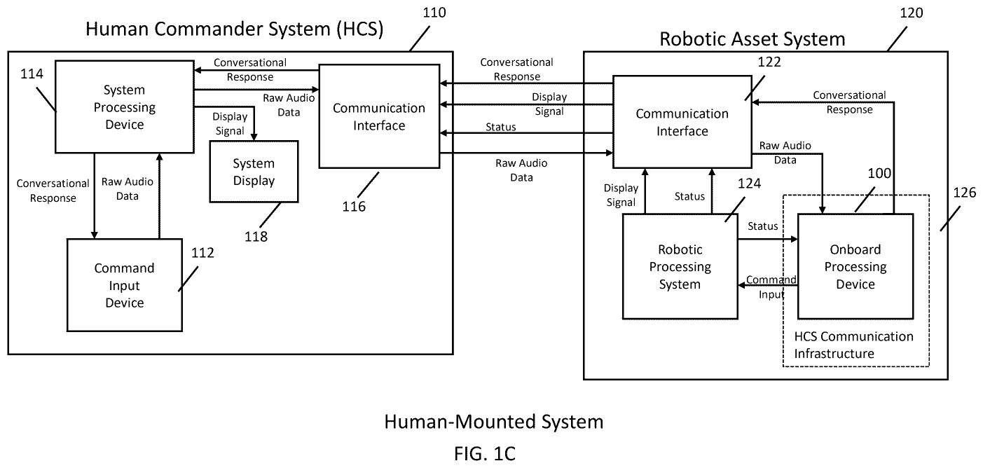

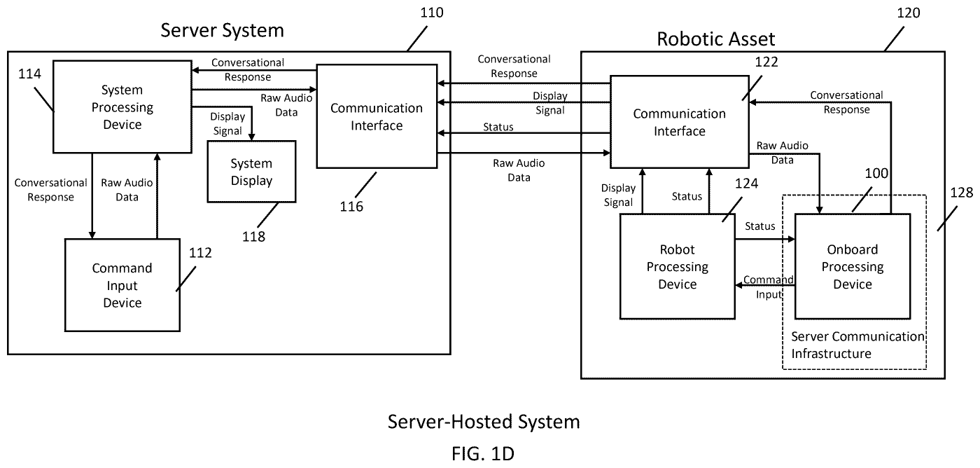

FIG. 1A illustrates a system for command and control of a remote autonomous object in accordance with an exemplary embodiment of the present disclosure. The system 100 can be configured for reducing the processing complexity at a network in response to natural language verbal commands.

As shown in FIG. 1A, the system 100 is an onboard processing device. The onboard processing device can be mounted to, integrated in, or physically and/or wirelessly connected to a remote autonomous system. According to exemplary embodiments of the present disclosure, a remote autonomous system can include a robotic system, a human-wearable system, and a server-hosted system. FIGS. 1B to 1D illustrate exemplary arrangements of a remote autonomous system which includes the onboard processing device.

FIG. 1B illustrates a robot-mounted system for command and control of a remote autonomous object in accordance with an exemplary embodiment of the present disclosure. As shown in FIG. 1B, the onboard processing device is mounted to the robotic asset system. The robotic asset system includes a robotic processing system and a communication interface. The robotic processing system provides all control and processing of data on the robotic platform and the communication interface for establishing two-way communication with the human commander system. The human commander system 110 includes a system processing device 114, a command input device 112, a system display 118, and a communication interface 116. The command input device 112 can be configured to receive the verbal command of the user as raw audio data. According to an exemplary embodiment, the command input device 112 can be a microphone, headset, or any suitable voice input device as desired. The system processing device 114 can be configured to perform data control and management for the human commander system. The system processing device 114 can receive the raw audio data from the command input device and sends it to the robotic asset system 120 via the communication interface 116. The system processing device 114 can be configured to perform signal processing and generate transcribed audio data from the raw audio data. The system display 118 can be configured to receive display signals from the robotic asset system 120 and/or the system processing device 114.

FIG. 1C illustrates a human-mounted system for command and control of a remote autonomous object in accordance with an exemplary embodiment of the present disclosure. FIG. 1D illustrates a server-hosted system for command and control of a remote autonomous object in accordance with an exemplary embodiment of the present disclosure. FIGS. 1C and 1D are configured such that the onboard processing device is integrated into the robotic asset system. As shown in FIGS. 1C and 1D, the onboard processing device is configured with communication infrastructure allowing for communication with the human commander system and the server-hosted system, respectively. Further details regarding the operation of the operation of systems of FIGS. 1B to 1D will be provided in the discussion that follows.

The onboard processing device 100 can be configured to execute program code for generating plural sub-components for processing a natural language command. The plural sub-components of the onboard processing device can include a communication interface 102, a basic processor module 104, a conversational edge module 106, and an intent handler module 108. The plural sub-components can be connected and arranged for processing the user command or data associated with the user command in simple processing path (SPP) and a complex processing path (CPP) for processing the verbal command.

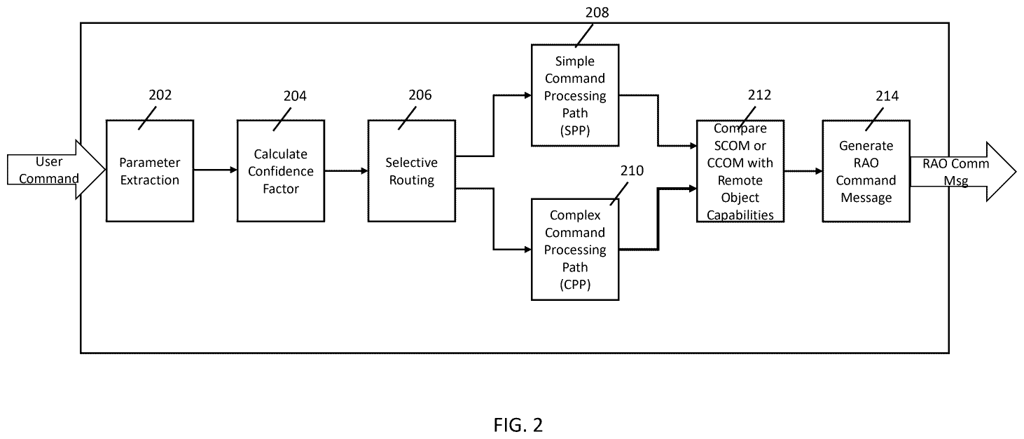

The communication interface 102 can be configured as an input/output interface and include one or more components for sending and/or receiving data to one or more external devices and/or over a network. FIG. 2 illustrates a data flow diagram for the system of FIG. 1 in accordance with an exemplary embodiment of the present disclosure. According to an exemplary embodiment, the communication interface 102 can receive a user command 202 in a natural language format, such as transcribed audio data. For example, the communication interface 102 can be configured to establish wireless and/or wired communication with voice and/or command input device 112 of a user, such as a microphone, headset, or other suitable input device as desired. The communication interface 102 can also be configured to include an application programming interface that can establish two-way communication between a browser executing on the remote autonomous system and a server on a network. The communication interface 108 can be configured to transmit or exchange data using any communication standard or protocol suitable for successfully establishing the communication session with a remote device. According to exemplary embodiments, the communication standards can include, for example, Hypertext Transfer Protocol, Hypertext Transfer Protocol Secure, User Datagram Protocol, WebSocket, Transmission Control Protocol, or gRPC Remote Procedure Calls.

The basic processor module 104 can be configured to receive the user command from the communication interface and extract designated parameters 202 from the user command for matching with a control prompt stored in a library of control prompts, and determining a confidence factor 204 with which the matching has been performed relative to a predetermined threshold. According to an exemplary embodiment, the basic processor module can be configured to include an interface, such as FastAPI for pulling the transcribed audio into a processing function of the basic processor module. The processing function can be configured for deduced intent natural language understanding where the designated parameters targeted for extraction include a subject, object, and verb (SOV) of the transcribed audio. The basic processor module 104 compares the SOV to control prompt entries in a natural language prompt library. According to an exemplary embodiment the natural language lightweight prompt library is stored in a portion of the basic processor module or resident memory of the onboard processing device. The basic processor module generates a confidence factor based on a result of the comparison. The confidence factor can be expressed as a percentage, or any suitable numerical or scoring format as desired.

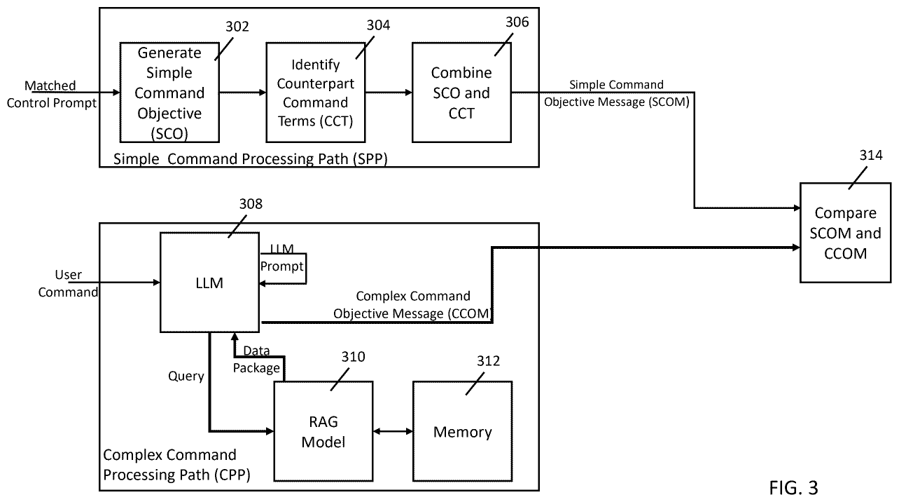

The basic processor module 104 selectively routes the user command to a simple command processing path (SPP) or a complex command processing path (CPP) based on the confidence factor. FIG. 3 illustrates selective routing command processing paths in accordance with an exemplary embodiment. For example, if the confidence factor meets or exceeds the predetermined threshold, the basic processor 102 selects the SPP for processing the designated parameters (SOV). If the confidence factor is less than the predetermined threshold, the basic processor 104 selects the CPP for processing the designated parameters (SOV).

As shown in FIG. 3, the SPP is configured for generating a simple command objective message (SCOM) that includes a simple command objective 302 (e.g., a simple intent) generated from the control prompt matched to the designated parameters (SOV) and a conversational counterpart 304 retrieved from a conversational library. For example, in routing the designated parameters to the SPP, the basic processor 104 compares the designated parameters to entries in natural language lightweight prompt library. When a match is found, the basic processor 104 generates the simple command objective from the control prompt matched to the extracted designated parameters. The basic processor 104 uses the designated parameters to identify conversational counterpart command terms 304 in a conversational library, which is stored in memory onboard processing device 100 or a storage location of the onboard processing device 100 associated with the basic processor 104. The counterpart command terms can be conversational terms that are directed to or for understanding by a human audience and can be used by the basic processor 104 to generate a response to the user command. For example, a counterpart command terms can convey: Pre-Action Confirmation, Action Acknowledgment, Status Updates, Responses to Questions, or Requests for more information in case of incomplete prompts. The basic processor 104 combines the simple command objective and the conversational counterpart command terms 306 to generate the simple command objective message.

According to an exemplary embodiment, when the confidence factor is below the predetermined threshold, the basic processor 104 selects the CCP for processing the user command. For example, the basic processor 104 passes the transcribed audio to the conversational edge module 106 for processing. The conversational edge module 106 is configured to include at least one neural network providing a large language model (LLM) 308 for generating a complex command objective and providing a retrieval augmented generation (RAG) model 310 for producing a context data package. The LLM 308 can further include a KELSIE LLM and Modular Logic & Reasoning-Based LLM for generating the complex command message. The conversational edge module 106 processes the user command to extract library content (e.g., a data package) from memory 312, identify context and situational awareness related to the user command, and generate a complex command message that represents an intent of the user command as determined by the conversational edge module 106.

According to an exemplary embodiment, the LLM 308 receives the user command as an input to build the LLM prompt. The LLM queries the RAG model 310 for context data that is semantically related to the user command. When the query is received from the LLM 308, the RAG model 310 compares the user command with context data stored in memory 312 associated with the RAG model 310 or the onboard processing device 100. Based on the comparison operation, the RAG model 310 identifies one or more context data elements that are semantically related to the user command and that specify a related context and situational awareness of the user command. The RAG model 310 returns the context data package including semantically related context data to the LLM 308. The LLM 308 then combines the user command and the data package to generate the LLM prompt. The LLM 308 uses the LLM prompt to generate a complex command objective message. According to an exemplary embodiment, the LLM includes a Prompt Template which provides instructions for how to structure the response. For example, the Prompt Template can include instructions for creating the Command text format (e.g., JSON) and Conversational Counterpart. The JSON portion defines what format the JSON needs to be in for the recipient to process a command, and the Conversational Counterpart instructs the LLM 308 on tone and length of response. In our case that instruction looks like “You are a friendly Naval Officer who responds in one sentence that is direct and to the point”.

The intent handler 108 can receive the simple command objective message from the basic processor 104 or the complex command objective message from the conversational edge module 106, which are generated as a result of the selective routing operation 206. The result of the selective routing operation being one of the simple command objective message generated by the simple command processing path (SPP) 208 or the complex command objective message generated by the complex command processing path (CPP) 210 is compared with known capabilities of the remote autonomous object 212 to identify a remote autonomous object command (RAO). The intent handler 108 can generate a remote autonomous object command message 214 containing the remote autonomous object command for transmission to the remote autonomous object.

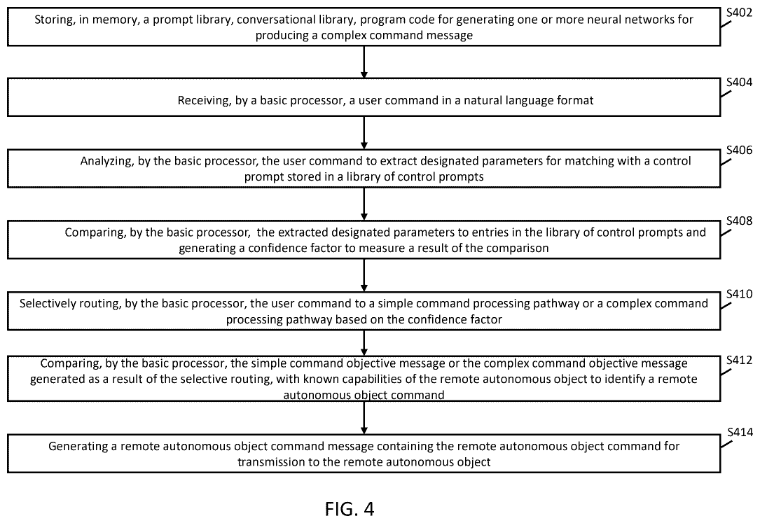

FIG. 4 illustrates a method for command and control of a remote autonomous object in response to natural language commands in accordance with an exemplary embodiment.

The method 400 can be performed by a processing device 100 mounted to, integrated in, or physically and/or wirelessly connected to a remote autonomous system, which can include a robotic system, a human-wearable system, and a server-hosted system. In executing the method 400, the processing device 100 stores, in memory, a prompt library, a conversational library, program code for generating one or more neural networks for producing a complex command message (S402). In a step S404, the processing device 100 receives a user command in a natural language format. The user command can be received by the processing device 100 as transcribed audio data via the communications interface 102 which can be configured for establishing two-way communication over radio frequency, a data network, the Internet, or any suitable communication format as desired. In step S406, the processing device 100 analyzes the user command to extract designated parameters (e.g., a subject, an object, and verb) for matching with a control prompt stored in a library of control prompts. For example, the library of control prompts can be stored in resident memory of the processing device 100. The processing device 100 performs a natural language processing operation on the user command by analyzing the transcribed audio data to identify and extract the designated parameters. The processing device 100 compares the extracted designated parameters to the entries in the library of control prompts and generates a confidence factor to measure a result of the comparison (S408). The confidence factor can be a percent value, which is compared to a predetermined threshold for allocating processing resources to determine an object and/or intent of the user command so that the remote autonomous system can perform the desired task.

In step S410, the processing device 100 selectively routes the user command to a simple command processing path (SPP) or a complex command processing path (CPP) based on the confidence factor. If the confidence factor is equal to or greater than the predetermined threshold, the processing devices routes the user command to the SPP. Alternatively, if the confidence factor is less than the predetermined threshold the processing device 100 routes the user command to the CPP 210. The SPP 208 includes the basic processor 104 and the intent handler 108 which generates a simple command message that includes a simple command objective representing the user's intent or intended action to be performed by the remote automation system. Through the SPP 208, the simple command objective is generated from the control prompt (from NLU that is matched to the designated parameters and a conversational counterpart retrieved from a conversational library. The CPP 210 includes plural neural networks, such as the LLM 308 and a RAG model 310, in which the LLM prompts the RAG model 310 to access and extract library content (e.g., a data package) from a library based on the natural language content of the user command. The data package identifies context and situational awareness that is semantically related to the user command. The LLP 308 generates a complex command message representing the user's intent or intended action to be performed by the remote automation system based on the library content.

Once either the simple command objective message or the complex command objective message is generated based on the selective routing operation 206, the processing device 100 compares the simple command objective message or the complex command objective message generated as a result of the selective routing operation 206, with known capabilities of the remote autonomous object to identify a remote autonomous object command (S412). In step S414, the processing device 100 generates a remote autonomous object command message containing the remote autonomous object command for transmission to the remote autonomous object. According to an exemplary embodiment, the communication interface 102 can format the message for transmission in the desired format or according to the selected communication protocol.

According to the exemplary embodiments of the present disclosure, the processing device can reduce the computational overhead and power consumption of processing devices in isolated and/or contested environments. The exemplary systems and methods perform operations that result in improved natural language processing at an edge device and provide more than what is currently well-understood, routine, and conventional in the field of natural language processing and command and control of remote autonomous systems. More specifically, selective routing operation allows the processing device to evaluate a command based on mission relevant information associated or relevant to a contested environment, such as, an area experiencing one or more of the following: military conflict or exercise, harsh or severe environmental conditions (ocean, mountainous regions, severe heat, cold, wind, or snow, etc.,), limited or restricted access by humans (e.g., outer space or interplanetary locations), thereby limiting or eliminating the need for additional clarifying dialogue and communication between the remote autonomous system and a user. As a result, a remote autonomous system can perform the desired or intended action based on receipt of an initial natural language command of a user. According to exemplary embodiments of the present disclosure, the mission relevant information can include contextual and semantic data and information related to search and rescue operations, underwater operations, in-the field medical support, outer space and planetary exploration.

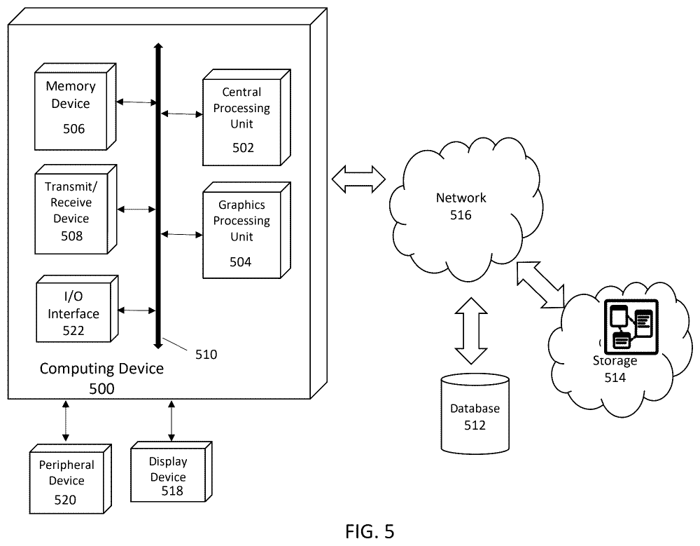

As shown in FIG. 5 a computing device 500 configured for performing the exemplary embodiments described herein can be configured to include a central processing unit (CPU) 502, a graphics processing unit (GPU) 504, a memory device 506, and a transmit/receive device 508. The CPU 502 can include a special purpose, or a general purpose hardware processing device encoded with program code or software for scheduling and executing processing tasks associated with the overall operation of the computing device 500. For example, the CPU 502 can establish the platform necessary for executing operations as an onboard processing device 100. The CPU 502 can be connected to a communications infrastructure 510 including a bus, message queue, network, multi-core message-passing scheme, etc., for communicating data and/or control signals with other hardware components. According to an exemplary embodiment, the CPU 502 can include one or more processing devices such as a microprocessor, central processing unit, microcomputer, programmable logic unit or any other suitable hardware processing device as desired. The GPU 504 can include a combination of hardware and software components, such as a special purpose hardware processing device being configured to execute or access program code or software for rendering images in a frame buffer for display. For example, the GPU 504 can include an arithmetic logic unit, at least 128 KB of on-chip memory, and be configured with an application program interface such as Vulkan, OpenGL ES (Open Graphics Library for Embedded Systems), OpenVG (OpenVector Graphics), OpenCL (Open Computing Language), OpenGL (Open Graphics Library), Direct3D, or any other suitable hardware and/or software platform as desired for executing a customized image generation application or process as described herein.

The computing device 500 can also include a memory device 506. The memory device 506 can be configured to store data for performing the operations for realizing the exemplary embodiments described herein. The memory device 506 can include one or more memory devices such as volatile or non-volatile memory. For example, the volatile memory can include random access memory, read-only memory, etc. The non-volatile memory of the memory device 506 can include one or more resident hardware components such as a hard disk drive and a removable storage drive (e.g., a floppy disk drive, a magnetic tape drive, an optical disk drive, a flash memory, or any other suitable device). The non-volatile memory can include an external memory device such as a database 512 and/or cloud storage 514 connected to the computing device 500 via the network 516. According to an exemplary embodiment, the non-volatile memory can include any combination of resident hardware components or external memory devices. Data stored in computing device 500 (e.g., in a non-volatile memory) may be stored on any type of suitable computer readable media, such as optical storage (e.g., a compact disc, digital versatile disc, Blu-ray disc, etc.) or magnetic tape storage (e.g., a hard disk drive). The stored data can include image data generated by the GPU 504, control and/or system data stored by the CPU 502, and software or program code used by the CPU 502 and/or GPU 504 for performing the tasks associated with the exemplary embodiments described herein. The data may be configured in any type of suitable database configuration, such as a relational database, a structured query language (SQL) database, a distributed database, an object database, etc. Suitable configurations and storage types will be apparent to persons having skill in the relevant art.

The transmit/receive device 508 can include a combination of hardware and software components for communicating with other computing devices connected to the network 516. The transmit/receive device 508 can be configured to transmit/receive data signals and/or data packets over the network 516 according to a specified communication protocol and data format. During a receive operation, the transmit/receive device 508 can identify parts of the received data via the header and parse the data signal and/or data packet into small frames (e.g., bytes, words) or segments for further processing by the CPU 502 or GPU 504. During a transmit operation, the transmit/receive device 508 can assemble data received from the CPU 502 or GPU 504 into a data signal and/or data packets according to the specified communication protocol and/or data format of the network 516 or external receiving device. The transmit/receive device 508 can include one or more receiving devices and transmitting devices for providing data communication according to any of a number of communication protocols and data formats as desired. For example, the transmit/receive device 508 can be configured to communicate over the network 516, which may include a local area network (LAN), a wide area network (WAN), a wireless network (e.g., Wi-Fi), a mobile communication network, a satellite network, the Internet, optic fiber, coaxial cable, infrared, radio frequency (RF), or any combination thereof. Other suitable network types and configurations will be apparent to persons having skill in the relevant art. According to an exemplary embodiment, the transmit/receive device 116 can include any suitable hardware components such as an antenna, a network interface (e.g., an Ethernet card), a communications port, a PCMCIA slot and card, or any other suitable communication components or devices as desired.

The computing device 500 can include a display device 518 configured to display one or more interfaces and/or images generated by the CPU 502 and GPU 504. The GPU 504 can be configured to generate a data signal encoded with the video data and send the data signal to the display device 518 via the communications infrastructure 510. The display device 518 can include any one of several types of displays including light emitting diode (LED), micro-LED, organic LED (OLED), active-matrix organic LED (AMOLED), Super AMOLED, thin film transistor (TFT), TFT liquid crystal display (TFT LCD), in-plane switching (IPS), or any other suitable display type as desired. According to an exemplary embodiment, the display device 518 can be configured to have a resolution at any of 5K, 4K, 2K, high definition (HD), full HD, and a refresh rate including any one of 60 Hz, 90 Hz, 120 Hz or any other suitable resolution and refresh rate as desired.

The peripheral device 520 is configured to output the data signal in a format selected by a user. For example, the peripheral device 520 can be implemented as another display device, printer, speaker, or any suitable output device with a desired output format as desired. In addition, the I/O peripheral device 520 can be configured to provide a data signal to the CPU 502 or GPU 504 via the I/O interface 522. According to an exemplary embodiment, the peripheral device 520 can be connected to receive data from the network 516 via computing device 500, and more particularly via the input/output (I/O) interface 522. The I/O interface 522 can include a combination of hardware and software components. The I/O interface 522 can be configured to convert the output of the network 516 into a format suitable for output on one or more types of peripheral devices 520.

The computer program code for performing the specialized functions described herein can be stored on a computer usable medium, which may refer to memories, such as the memory devices for the computing device 500, which can be memory semiconductors (e.g., DRAMs, etc.). These computer program products can be a tangible non-transitory means for providing software to the various hardware components of the respective devices as needed for performing the tasks associated with the exemplary embodiments described herein. The computer programs (e.g., computer control logic) or software can be stored in the memory device. According to an exemplary embodiment, the computer programs can also be received and/or remotely accessed via the receiving device 508 of the computing device 500 as needed. Such computer programs, when executed, can enable the computing device 500 to implement the present methods and exemplary embodiments discussed herein, and may represent controllers of the computing device 500. Where the present disclosure is implemented using software, the software can be stored in a non-transitory computer readable medium and loaded into the computing device 500 using a removable storage drive, an interface, a hard disk drive, or communications interface, etc., where applicable.

The one or more processors of the computing device 500 can include one or more modules or engines configured to perform the functions of the exemplary embodiments described herein. Each of the modules or engines can be implemented using hardware and, in some instances, can also utilize software, such as program code and/or programs stored in memory. In such instances, program code may be compiled by the respective processors (e.g., by a compiling module or engine) prior to execution. For example, the program code can be source code written in a programming language that is translated into a lower level language, such as assembly language or machine code, for execution by the one or more processors and/or any additional hardware components. The process of compiling can include the use of lexical analysis, preprocessing, parsing, semantic analysis, syntax-directed translation, code generation, code optimization, and any other techniques that may be suitable for translation of program code into a lower level language suitable for controlling the computing device 500 to perform the functions disclosed herein. It will be apparent to persons having skill in the relevant art that such processes result in the computing device 500 being specially configured computing devices uniquely programmed to perform the functions discussed above.

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description and all changes that come within the meaning and range and equivalence thereof are intended to be embraced therein.

What is claimed is:

1. Method for reducing processing complexity for command and control of a remote autonomous object in response to natural language commands, the method comprising:
storing, in memory, a prompt library, a conversational library, program code for generating one or more neural networks for producing a complex command message;
receiving, at a basic processor, a user command in a natural language format;
extracting, by the basic processor, designated parameters from the user command for matching with a control prompt stored in a library of control prompts, and determining a confidence factor with which the matching has been performed relative to a predetermined threshold;
selectively routing, by the basic processor, the user command to a simple command processing path or a complex command processing path based on the confidence factor, the simple command processing path configured for generating a simple command message that includes a simple command objective generated from the control prompt matched to the designated parameters and a conversational counterpart retrieved from a conversational library, and the complex command processing path having one or more neural networks that process the user command to extract library content identifying context and situational awareness that is semantically related to the user command, and generate a complex command message based on the library content;
comparing, by the basic processor, the simple command objective message or the complex command objective message generated because of the selective routing, with known capabilities of the remote autonomous object to identify a remote autonomous object command; and
generating a remote autonomous object command message containing the remote autonomous object command for transmission to the remote autonomous object.

2. The method according to claim 1, comprising:
selectively routing the user command to the simple command processing path when the confidence factor meets or exceeds the predetermined threshold.

3. The method according to claim 1, wherein generating the simple command message comprises:
generating the simple command objective from the control prompt matched to the extracted designated parameters;
identifying counterpart command terms in the conversational library using the extracted designated parameters; and
combining the simple command objective and the counterpart command terms into a processed simple command message.

4. The method according to claim 1, comprising:
selectively routing the user command to the complex command processing path when the confidence factor is below the predetermined threshold.

5. The method according to claim 1, wherein generating the complex command message comprises:
executing, by the basic processor, the program code stored in memory, the program code causing the basic processor to generate at least: a large language model (LLM) for producing an LLM prompt, a retrieval augmented generation (RAG) model for producing a context data package, and the LLM being further configured for generating the complex command objective;
passing the user command to the LLM to build the LLM prompt, the LLM querying the RAG model for context data that is semantically related to the user command;
returning, by the RAG model, the context data package including semantically related context data to the LLM;
combining, by the LLM, the user command and the data package to generate the LLM prompt; and
passing the LLM prompt to an input of the LLM model to generate a complex command objective message.

6. The method according to claim 5, comprising:
comparing, by the RAG model, the user command with context data stored in memory, and
identifying one or more context data elements that are semantically related to the user command and that specify a related context and situational awareness of the user command.

7. The method according to claim 6, wherein the context data stored in memory comprises:
a Pre-Mission Upload including Constitution and Warfighter Operational Context, ethical guidelines, a mission brief, all prior user commands, Robot Status data, LLM Conversational Responses, situational awareness context data, and a preceding user command.

8. The method according to claim 6, wherein the preceding user command immediately precedes a current user command.

9. System for reducing processing complexity for command and control of a remote autonomous object in response to natural language commands, the system comprising:
memory configured to store a prompt library, a conversational library, and program code for generating one or more neural networks for producing a complex command message; and
a basic processor configured to:
receive a user command in a natural language format;
extract designated parameters from the user command for matching with a control prompt stored in a library of control prompts, and determining a confidence factor with which the matching has been performed relative to a predetermined threshold;
selectively route the user command to a simple command processing path or a complex command processing path based on the confidence factor, the simple command processing path configured for generating a simple command message that includes a simple command objective generated from the control prompt matched to the designated parameters and a conversational counterpart retrieved from a conversational library, and the complex command processing path having one or more neural networks that process the user command to extract library content identifying context and situational awareness related to the user command, and generate a complex command message based on the library content;
compare the simple command objective message or the complex command objective message generated as a result of the selective routing, with known capabilities of the remote autonomous object to identify a remote autonomous object command; and
generate a remote autonomous object command message containing the remote autonomous object command for transmission to the remote autonomous object.

10. The system according to claim 9, wherein the basic processor is configured to:
selectively route the user command to the simple command processing path when the confidence factor meets or exceeds the predetermined threshold.

11. The system according to claim 9, wherein to generate the simple command message, the basic processor is configured to:
generate the simple command objective from the control prompt matched to the extracted designated parameters;
identify counterpart command terms in the conversational library using the extracted designated parameters; and
combine the simple command objective and the counterpart command terms into a processed simple command message.

12. The system according to claim 9, wherein the basic processor is configured to:
selectively route the user command to the complex command processing path when the confidence factor is below the predetermined threshold.

13. The system according to claim 9, wherein to generate the complex command message, the basic processor is configured to:
execute the program code stored in memory, the program code causing the basic processor to generate at least: a large language model (LLM) for producing an LLM prompt, a retrieval augmented generation (RAG) model for producing a context data package, and a second LLM for producing the complex command objective;
pass the user command to the LLM to build the LLM prompt, the LLM querying the RAG model for context data that is semantically related to the user command;
return, by the RAG model, the context data package including semantically related context data to the LLM;
combine, by the LLM, the user command and the data package to generate the LLM prompt; and
pass the LLM prompt to the input of the LLM model to generate a complex command objective message.

14. The system according to claim 13, wherein the basic processor is configured to:
compare, by the RAG model, the user command with context data stored in memory, and
identify one or more context data elements that are semantically related to the user command and that specify a related context and situational awareness of the user command.

15. The system according to claim 14, wherein the context data stored in memory comprises:
a Pre-Mission Upload including Constitution and Warfighter Operational Context, ethical guidelines, a mission brief, all prior user commands, Robot Status data, LLM Conversational Responses, situational awareness context data, and a preceding user command.

16. The system according to claim 1, mounted on the remote autonomous vehicle.

17. The system according to claim 1, mounted in a human-wearable article.

18. The system according to claim 1, mounted in a server configured to receive the user command over a network.

19. A non-transitory computer readable medium encoded with program code for performing a method for reducing processing complexity for command and control of a remote autonomous object in response to natural language commands, which when placed in communicable contact with a processor, causing the processor to perform operations comprising:
storing, in memory, a prompt library, a conversational library, program code for generating one or more neural networks for producing a complex command message;
receiving, at a basic processor, a user command in a natural language format;
extracting, by the basic processor, designated parameters (subject, object verb—SOV) from the user command for matching with a control prompt stored in a library of control prompts, and determining a confidence factor with which the matching has been performed relative to a predetermined threshold;
selectively routing, by the basic processor, the user command to a simple command processing path or a complex command processing path based on the confidence factor, the simple command processing path configured for generating a simple command message that includes a simple command objective generated from the control prompt matched to the designated parameters and a conversational counterpart retrieved from a conversational library, and the complex command processing path having one or more neural networks that process the user command to extract library content identifying context and situational awareness that is semantically related to the user command, and generate a complex command message based on the library content;
comparing, by the basic processor, the simple command objective message or the complex command objective message generated as a result of the selective routing, with known capabilities of the remote autonomous object to identify a remote autonomous object command; and
generating a remote autonomous object command message containing the remote autonomous object command for transmission to the remote autonomous object.
